(19) United States
(12) Patent Application Publication
(10) Pub. No.: US 2026/0003887 A1
(43) Pub. Date: Jan. 1, 2026

(54) DATA DISTRIBUTION WITH CLOUD REPLICATION CACHE

(71) Applicant: Snowflake Inc., Bozeman, MT (US)

(72) Inventors: Hitesh Madan, Seattle, WA (US); Ojasvi Rajpal, Sunnyvale, CA (US); Sanjay Srivastava, Mountain View, CA (US); Chieh-Sheng Wang, San Mateo, CA (US); Di Wu, Newark, CA (US)

(21) Appl. No.: 18/758,420

(22) Filed: Jun. 28, 2024

(51) Int. Cl. G06F 16/27; G06F 11/34; G06F 16/2453; G06F 16/25; G06F 21/60

(52) U.S. Cl. CPC G06F 16/27; G06F 11/3419; G06F 16/24542; G06F 16/256; G06F 21/602

(57) ABSTRACT

A data platform is provided that uses a replication cache to replicate data. The data platform is designed to receive a replication request from a secondary deployment that includes a request for a data transfer of data files from a primary deployment. The data platform analyzes metadata of a replication cache and the primary deployment to identify the data files for replication. Based on this metadata, the data platform determines whether to route the data transfer through the replication cache or directly from the primary deployment to the secondary deployment. The data transfer is then routed accordingly, and the receipt of the data transfer at the secondary deployment is verified.

### TECHNICAL FIELD

Examples of the disclosure relate generally to data platforms and, more specifically, to replicating data between database deployments.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems. Cloud-based data platforms may communicate data between databases.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform in communication with a cloud storage provider user system, according to some examples.

FIG. 2 is a block diagram illustrating components of a compute service manager, according to some examples.

FIG. 3 is a block diagram illustrating components of an execution platform, according to some examples.

FIG. 4 is a deployment diagram of a database system deployment in accordance with some embodiments of the present disclosure.

FIG. 5 illustrates a data transfer routing method, according to some examples.

FIG. 6A, FIG. 6B, and FIG. 6C illustrate a replication using a replication cache, according to some examples.

FIG. 7A and FIG. 7B illustrate a point to point replication method, according to some examples.

FIG. 8 illustrates a diagrammatic representation of a machine in the form of a computer system within which a set of instructions may be executed for causing the machine to perform any one or more of the methodologies discussed herein, according to some examples.

### DETAILED DESCRIPTION

Organizations across various industries face escalating challenges in managing and synchronizing data across multiple cloud environments. As enterprises expand their operations globally, they increasingly rely on cloud platforms dispersed across different regions, which complicates data accessibility and consistency. The traditional methods of data replication often result in high latency, increased costs, and complexities in maintaining data integrity across geographically dispersed systems. These challenges are compounded by the growing volume and velocity of data generated by modern digital activities.

There is a desire for advanced methodologies that can streamline the process of data replication while minimizing associated costs and operational burdens. The methodologies described in present disclosure address these issues by introducing more efficient data handling and transfer mechanisms that can reduce the overhead and expenses involved in multi-region data synchronization. By optimizing data replication processes, businesses can achieve faster data updates, enhanced reliability, and improved scalability, which are useful for supporting real-time decision-making and operational agility. The adoption of these improved methodologies not only supports better data management practices but also aligns with the strategic goals of enhancing overall business resilience and facilitating smoother expansion into new markets.

In some examples, by using the methodologies described in this disclosure, a system can select cost-effective replication strategies, thereby allowing organizations to reduce the costs associated with data replication, particularly in multi-cloud environments where data transfer costs can vary widely.

In some examples, the methodologies described in this disclosure provide for data replication that is not only cost-effective but also efficient. By optimizing data transfer methods and routes, the methodologies minimize the time and resources required for data replication, which can be useful for performance-sensitive applications.

In some examples, the methodologies described in this disclosure provide for a decision-making process designed to be scalable and flexible, capable of handling varying data volumes and adapting to changes in cloud infrastructure or pricing models. This adaptability is useful when maintaining cost efficiency in dynamic cloud environments.

In some examples, the methodologies described in this disclosure provide for cost optimization, allowing organizations to enhance their overall data management practices. By reducing costs and improving efficiency, organizations can afford to replicate data more frequently or to more locations, which can improve data availability and business continuity.

In some examples, a data platform receives a replication request from a secondary deployment among one or more secondary deployments. This request involves a data transfer of one or more data files from a primary deployment. The data platform analyzes metadata of a replication cache and the primary deployment to identify the data files for replication. Based on this metadata, the data platform determines whether to route the data transfer through the replication cache or directly from the primary deployment to the secondary deployment. The data transfer is routed accordingly, and the receipt of the data transfer at the secondary deployment is verified.

In some examples, the data platform updates the replication cache with the latest version of the data files from the primary deployment before routing the data transfer through the replication cache.

In some examples, determining whether to route the data transfer through the replication cache or directly from the primary deployment is further based on a comparison of historical data transfer rates for previous replication activities to current data transfer rates.

In some examples, the determination of routing the data transfer through the replication cache or directly from the primary deployment is further based on a real-time analysis of the cost of the data transfer.

In some examples, the data platform encrypts the data files during the data transfer process.

In some examples, the replication request includes specified data files designated for priority replication based on specific application requirements.

In some examples, the location of the replication cache is strategically chosen based on the access times of the one or more secondary deployments.

In some examples, the metadata used in analyzing the inventory includes timestamps indicating a last modification time of the data files, which assists in determining the freshness and relevance of the data.

In some examples, the data platform encrypts each of the one or more data files using a unique encryption key before routing the data transfer through the replication cache, enhancing data security.

In some examples, after the data transfer, the encrypted data files are decrypted at the secondary deployment using respective decryption keys unique to each secondary deployment, ensuring that the data can be securely and correctly accessed post-transfer.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

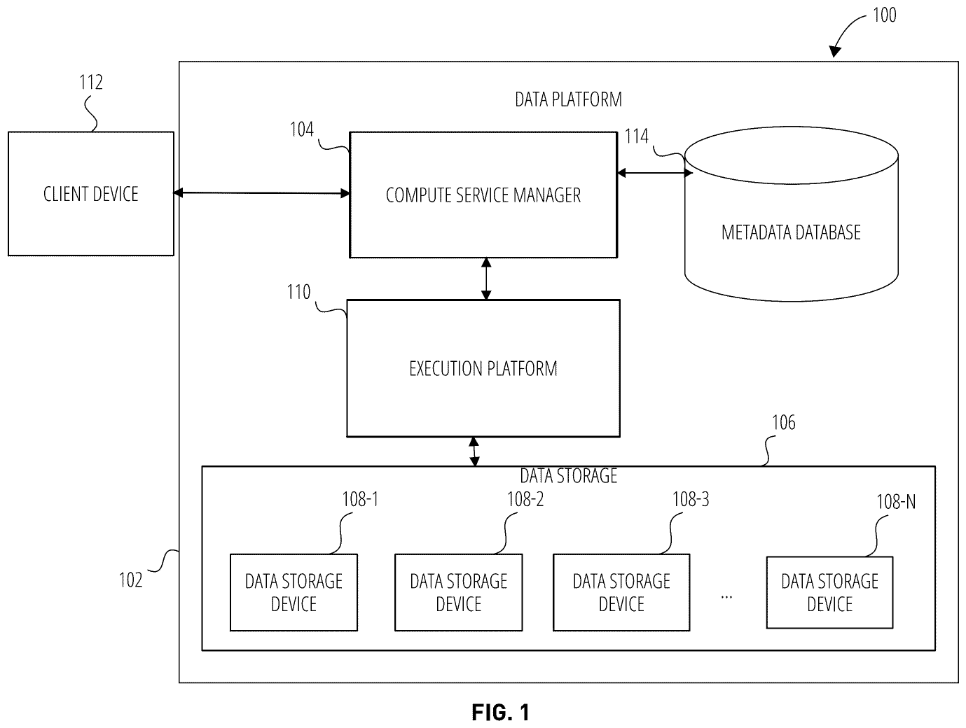

FIG. 1 illustrates an example computing environment 100 that includes a data platform 102 in communication with a client device 112, according to some examples. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a data storage 106, a compute service manager 104, an execution platform 110, and a metadata database 114. The data storage 106 comprises a plurality of computing machines and provides on-demand computer system resources such as data storage and computing power to the data platform 102. As shown, the data storage 106 comprises multiple data storage devices, such as data storage device 108-1, data storage device 108-2, data storage device 108-3, and data storage device 108-N. In some examples, the data storage devices 1 to N are cloud-based storage devices located in one or more geographic locations. For example, the data storage devices 1 to N may be part of a public cloud infrastructure or a private cloud infrastructure. The data storage devices 1 to N may be hard disk drives (HDDs), solid state drives (SSDs), storage clusters, Amazon S3™ storage systems or any other data storage technology. Additionally, the data storage 106 may include distributed file systems (e.g., Hadoop Distributed File Systems (HDFS)), object storage systems, and the like.

In some examples, one or more of the data storage devices 108-1 to 108-N are cloud-based datastores configured as Virtual Private Clouds (VPCs). In some examples, A VPC is a secure, isolated virtual network within a public cloud environment that allows organizations to run and manage their cloud resources with enhanced control and privacy. A VPC can provide the functionality of a traditional data center without the physical management and maintenance overhead, enabling users to define their own network space. This includes selecting IP address ranges, creating subnets, configuring route tables, and setting up network gateways. VPCs are beneficial for entities that desire a partitioned section of the cloud to ensure that their applications and data are isolated from other users on the same public cloud platform. This isolation helps in maintaining security and compliance with regulatory requirements, while also allowing for scalable and flexible resource management.

In some examples, data objects are stored in structured data files. The structured data files can be in various structured file formats such as, but not limited to, Comma-Separated Values (CSV) JavaScript Object Notation (JSON), Apache Avro (Avro), Apache Parquet (Parquet) Optimized Row Columnar (ORC), Extensible Markup Language (XML), and the like.

In some examples, the data platform 102 organizes data storage using micro-partitions of a database table using a suitable structured data file format specifically designed for optimal performance and security within the computing environment 100 such as, but not limited to, Flocon De Neige (FDN) and the like. Whenever new data is added to a table, new micro-partition files are created. This approach ensures that data is stored in an immutable format where the addition of a new record results in the generation of a new micro-partition file.

The data platform 102 is used for reporting and analysis of integrated data from one or more disparate sources including the storage devices 1 to N within the data storage 106. The data platform 102 hosts and provides data reporting and analysis services to multiple consumer accounts. Administrative users can create and manage identities (e.g., users, roles, and groups) and use privileges to allow or deny access to identities to resources and services. Generally, the data platform 102 maintains numerous consumer accounts for numerous respective consumers. The data platform 102 maintains each consumer account in one or more storage devices of the data storage 106. Moreover, the data platform 102 may maintain metadata associated with the consumer accounts in the metadata database 114. Each consumer account includes multiple objects with examples including users, roles, privileges, a datastores or other data locations.

The compute service manager 104 coordinates and manages operations of the data platform 102. The compute service manager 104 also performs query optimization and compilation as well as managing clusters of compute services that provide compute resources (also referred to as “virtual warehouses”). The compute service manager 104 can support any number and type of clients such as end users providing data storage and retrieval requests, system administrators managing the systems and methods described herein, and other components/devices that interact with compute service manager 104. As an example, the compute service manager 104 is in communication with the client device 112. The client device 112 can be used by a user of one of the multiple consumer accounts supported by the data platform 102 to interact with and utilize the functionality of the data platform 102. In some examples, the compute service manager 104 does not receive any direct communications from the client device 112 and only receives communications concerning jobs from a queue within the data platform 102.

The compute service manager 104 is also coupled to metadata database 114. The metadata database 114 stores data pertaining to various functions and examples associated with the data platform 102 and its users. In some examples, the metadata database 114 includes a summary of data stored in remote data storage systems as well as data available from a local cache. In some examples, the metadata database 114 may include information regarding how data is organized in remote data storage systems (e.g., the database storage 106) and the local caches. In some examples, the metadata database 114 include data of metrics describing usage and access by provider users and consumers of the data stored on the data platform 102. In some examples, the metadata database 114 allows systems and services to determine whether a piece of data needs to be accessed without loading or accessing the actual data from a storage device.

The compute service manager 104 is further coupled to the execution platform 110, which provides multiple computing resources that execute various data storage and data retrieval tasks. The execution platform 110 is coupled to the database storage 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle communication with a compute cluster for a given job provided by the compute service manager 104 and to communicate information back to the compute service manager 104 and other compute nodes of the execution platform 110.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices data storage device 108-1 to data storage device 108-N are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata database 114, execution platform 110, and data storage 106 are shown in FIG. 1 as individual discrete components. However, each of the compute service manager 104, metadata database 114, execution platform 110, and data storage 106 may be implemented as a distributed system (e.g., distributed across multiple systems/platforms at multiple geographic locations). Additionally, each of the compute service manager 104, metadata database 114, execution platform 110, and data storage 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the data storage 106. It is desirable to retrieve as much data as possible from caches within the execution platform 110 because the retrieval speed is typically faster than retrieving data from the data storage 106.

As shown in FIG. 1, the computing environment 100 separates the execution platform 110 from the data storage 106. In this arrangement, the processing resources and cache resources in the execution platform 110 operate independently of the database storage devices data storage device 108-1 to data storage device 108-N in the data storage 106. Thus, the computing resources and cache resources are not restricted to a specific one of the data storage device 108-1 to data storage device 108-N. Instead, computing resources and cache resources may retrieve data from, and store data to, any of the data storage resources in the data storage 106.

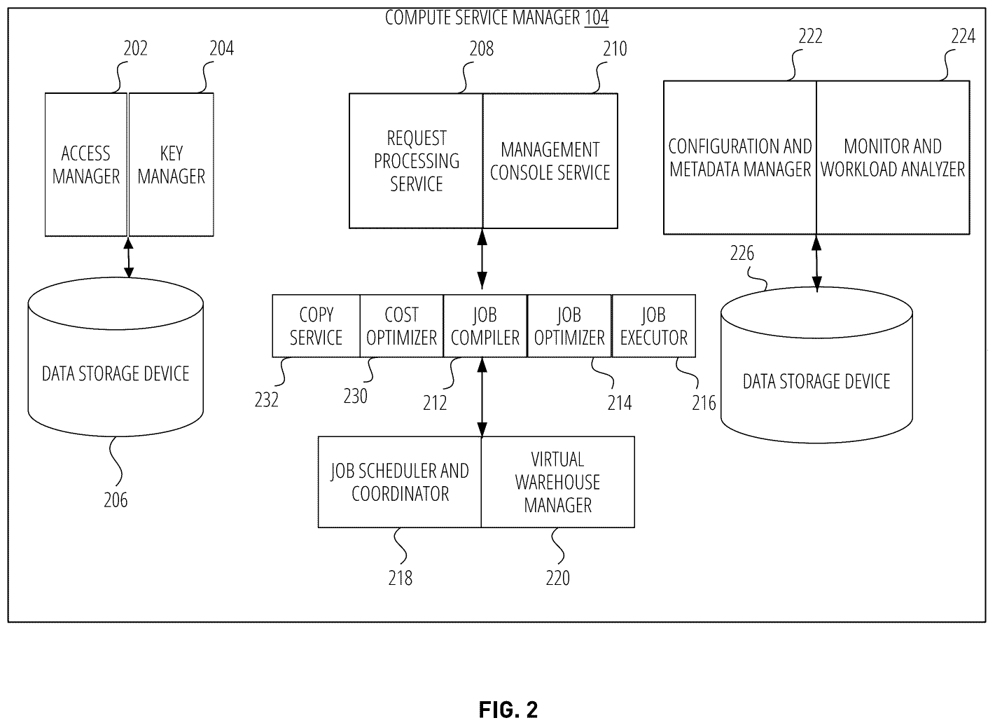

FIG. 2 is a block diagram illustrating components of the compute service manager 104, according to some examples. As shown in FIG. 2, the compute service manager 104 includes an access manager 202, and a key manager 204. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage data storage device 206). As used herein, the remote storage devices may also be referred to as “persistent storage devices” or “shared storage devices.”

In some examples, the access manager 202 operates within a data platform to control access to various objects of the data platform using Role-Based Access Control (RBAC). The access manager 202 is a component that manages authentication and authorization tasks, providing for authorized entities to access specific resources within the data platform. This component plays a role in maintaining the security and integrity of the data platform by enforcing access policies defined through RBAC.

In some examples, RBAC is implemented by defining roles within the data platform, where each role is associated with a specific set of permissions. These permissions determine the actions that entities assigned to the role can perform on various objects within the data platform. The access manager 202 utilizes these roles to make access control decisions, allowing or denying requests based on the roles assigned to the requesting entity and the permissions associated with those roles.

In some examples, the data platform creates specific access roles based on a manifest of an application received from an application package. These access roles are activated by the access manager 202 and are used to govern access to objects used by the application during operation. For example, an access role may grant the application the ability to create a compute pool and execute a service within that compute pool. The access manager 202 provides that an application, or entities authorized by the application, can perform actions permitted by the access role.

In some examples, the access manager 202 also controls access to objects of the data platform using the access roles during the execution of the service within the compute pool. The service accesses objects of the application package and of the data platform under the governance of the activated access roles. The access manager 202 checks the permissions associated with the access roles against the access requests made by the service, granting or denying these requests based on the defined RBAC policies.

In some examples, the role of the access manager 202 extends to managing access to hidden repositories within a provider account, where the application package is stored. The access manager 202 uses RBAC to restrict access to a hidden repository, providing for the application package to be accessible to entities with the appropriate access role. This mechanism protects the application package from unauthorized access, preserving the integrity of the provider's intellectual property.

In some examples, the access manager 202 implements RBAC to isolate the compute pool, preventing the service from accessing other services or resources not specified in the application package. This isolation is achieved by defining access roles that explicitly limit the service's permissions to the resources provided for the operation of the service, thereby enhancing the security of the service execution environment.

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 106.

A management console service 210 supports access to various systems and processes by administrators and other system managers. Additionally, the management console service 210 may receive a request to execute a job and monitor the workload on the system.

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 104.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the compute service manager 104 includes a configuration and metadata manager 222, which manages the information related to the data stored in the remote data storage devices and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in data storage 106, or any other storage device.

The compute service manager 104 validates communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 304a) may need to communicate with another execution node (e.g., execution node 304b), and should be disallowed from communicating with a third execution node (e.g., execution node 316a) and any such illicit communication can be recorded (e.g., in a log or other location). Also, the information stored on a given execution node is restricted to data relevant to the current query and any other data is unusable, rendered so by destruction or encryption where the key is unavailable.

The compute service manager 104 includes a cost optimizer 230 used by the compute service manager 104 to determine an optimal routing strategy for routing data transfers. The compute service manager 104 also includes a copy service 232 that implements the optimal routing strategy for routing data transfers as determined by the cost optimizer 230.

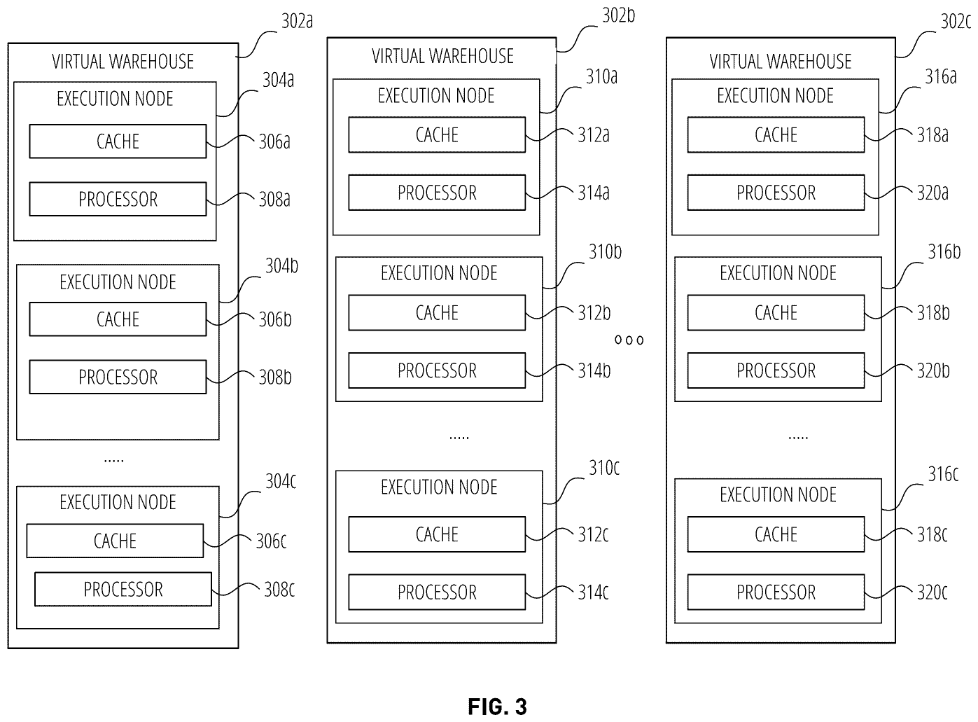

FIG. 3 is a block diagram illustrating components of the execution platform 110, according to some examples. As shown in FIG. 3, the execution platform 110 includes multiple virtual warehouses, including virtual warehouse 302a, and virtual warehouse 302b to virtual warehouse 302c. Each virtual warehouse includes multiple execution nodes that each includes a data cache and a processor. The virtual warehouses can execute multiple tasks in parallel by using the multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. Virtual warehouses can access data from any data storage device (e.g., any storage device in data storage 106).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 1 to N shown in FIG. 1. Thus, the virtual warehouses are not necessarily assigned to a specific data storage device 1 to N and, instead, can access data from any of the data storage devices 1 to N within the data storage 106. Similarly, each of the execution nodes shown in FIG. 3 can access data from any of the data storage devices 1 to N. In some examples, a particular virtual warehouse or a particular execution node may be temporarily assigned to a specific data storage device, but the virtual warehouse or execution node may later access data from any other data storage device.

In the example of FIG. 3, virtual warehouse 302a includes a plurality of execution nodes as exemplified by execution node 304a, execution node 304b, and execution node 304c. Execution node 304a includes cache 306a and a processor 308a. Execution node 304b includes cache 306b and processor 308b. Execution node 304c includes cache 306c and processor 308c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 302a discussed above, virtual warehouse 302b includes a plurality of execution nodes as exemplified by execution node 310a, execution node 310b, and execution node 310c. Execution node 304a includes cache 312a and processor 314a. Execution node 310b includes cache 312b and processor 314b. Execution node 310c includes cache 312c and processor 314c. Additionally, virtual warehouse 302c includes a plurality of execution nodes as exemplified by execution node 316a, execution node 316b, and execution node 316c. Execution node 316a includes cache 318a and processor 320a. Execution node 316b includes cache 318b and processor 320b. Execution node 316c includes cache 318c and processor 320c.

In some examples, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more data storage devices in data storage 106. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the data storage 106.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 3 has multiple execution nodes. The multiple execution nodes associated with each virtual warehouse may be implemented using multiple computing systems at multiple geographic locations. For example, an instance of virtual warehouse 302a implements execution node 304a and execution node 304b on one computing platform at a geographic location and implements execution node 304c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in data storage 106, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

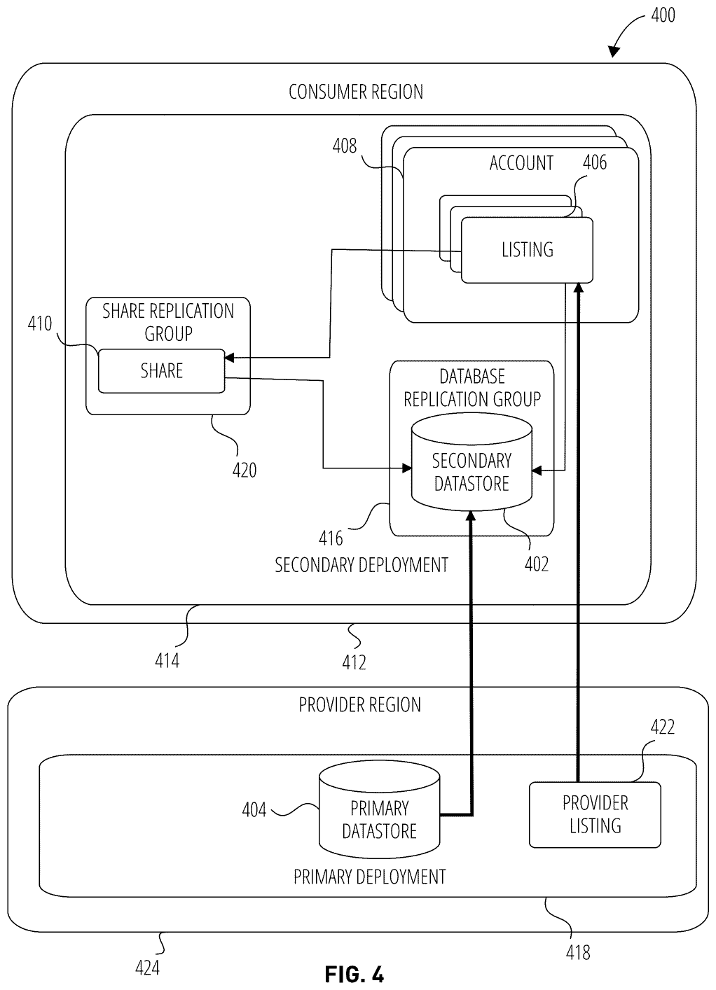

FIG. 4 is a deployment diagram of a database system deployment 400 in accordance with some embodiments of the present disclosure. A provider region 424 includes a primary deployment 418 including a primary datastore 404 that is maintained by a data provider. A consumer region 412 includes a secondary deployment 414 including a secondary datastore 402 which is a replica of the primary datastore 404 in the primary deployment 418. The secondary datastore 402 may be a complete copy of the primary datastore 404 or may include one or more slices of the primary datastore 404. The consumer region 412 includes one or more accounts, such as account 408. The one or more accounts are associated with one or more respective consumers of the data provided by the provider associated with the primary datastore 404. An account of the one or more accounts includes one or more listings, such as listing 406 of account 408, that correspond to one or more respective listings in the consumer region, such as provider listing 422. A listing points to one or more databases, such as secondary datastore 402 and one or more shares, such as share 410, that are associated with a database. Share 410 is populated with multiple objects including a pointer to the secondary datastore 402. The share 410 can be shared with various users, which grants those users access to those data files including access to secondary datastore 402.

A component of a database system, such as compute service manager 104 of FIG. 1, creates a secondary deployment 414 of the secondary datastore 402 and the share 410 associated with the secondary datastore 402 during execution of a fulfillment task associated with the listing 406. In some embodiments, during the fulfillment task, the compute service manager 104 creates a secondary deployment 414 of initial versions of the secondary datastore 402 and the share 410 for use by a consumer associated with the account 408. The compute service manager 104 generates a replica database in the secondary deployment 414 and copies data of primary datastore 404 to the replica database. The compute service manager 104 generates share 410 based on the secondary datastore 402. The compute service manager 104 links the replica database as secondary datastore 402 to the listing 406 and links the share 410 to the listing 406.

To maintain the secondary datastore 402, the compute service manager 104 executes a refresh task based on a refresh schedule maintained by a job scheduler and coordinator 218 of the compute service manager 104. In some embodiments, during a refresh task, the compute service manager 104 operates on replication groups of shares and databases, such as share replication group 420 and database replication group 416. The shares and databases of a consumer region are grouped into replication groups to facilitate refreshing the databases and shares in an orderly and consistent manner using one or more replication group objects. A replication group object is used to manage a replication group. The replication group object can include a manifest that lists multiple account objects (including one or more databases), that can be replicated together into the remote a deployment account, thereby generating replicated objects. To refresh the secondary datastore 402 of the database replication group 416 based on the primary datastore 404, the compute service manager 104 uses a replication group object to generate a replica database in the secondary deployment 414 and copies data of the primary datastore 404 to the replica database. The compute service manager 104 generates a replica share based on the secondary datastore 402. The compute service manager 104 links the listing 406 to the replica share as share 410 and links the replica database to the listing 406 as secondary datastore 402.

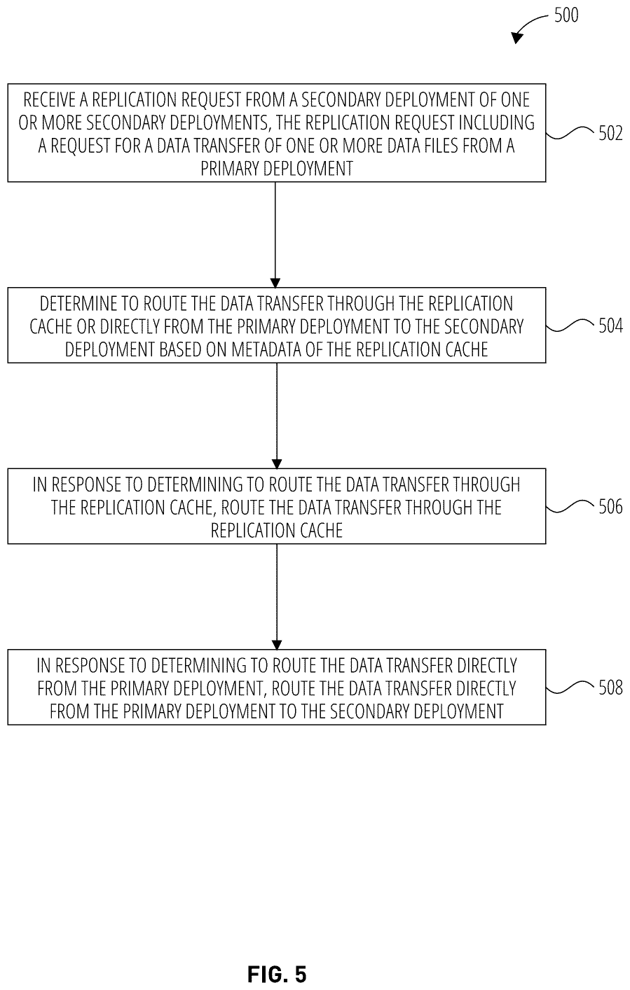

FIG. 5 illustrates an example data transfer routing method 500, according to some examples. A compute service manager of a data platform, such as compute service manager 104 of data platform 102 (both of FIG. 1), uses the data transfer routing method 500 to determine a routing strategy for routing a data transfer between deployments, such as a primary deployment 418 and secondary deployment 414 (both of FIG. 4) within a computing environment. Although the example data transfer routing method 500 depicts a particular sequence of operations, the sequence may be altered without departing from the scope of the present disclosure. For example, some of the operations depicted may be performed in parallel or in a different sequence that does not materially affect the function of the data transfer routing method 500. In other examples, different components of a compute service manager that implements the data transfer routing method 500 may perform functions at substantially the same time or in a specific sequence.

In operation 502, a compute service manager of a primary deployment receives a replication request from a secondary deployment. The replication request includes a request for a data transfer of one or more data files from the primary deployment. In some examples, the replication request includes a request for the transfer of one or more data files from the primary deployment. The process begins when the secondary deployment, which can be operating under different administrative domains or geographic locations than the primary deployment, identifies a need for specific data files that are not currently in its local datastore or that require updating due to changes in the primary deployment's datastore. The secondary deployment formulates a replication request. This request is structured to include identifiers of specific data files of database objects such as, but not limited to, database files, application data, system configurations, and the like, depending on the operational requirements of the secondary deployment. The request is transmitted to the primary deployment over a secure communication channel to ensure the integrity and confidentiality of the exchange.

In some examples, upon receiving the replication request, the compute service manager of the primary deployment processes the replication request to ascertain the availability and current status of the requested data files. This can include checking a primary datastore for the latest versions of the data files and preparing them for secure transmission back to the requesting secondary deployment. This preparation can include tasks such as, but not limited to, data compression for efficient transfer, encryption for security, packaging into a suitable format for transport over network infrastructures, and the like.

In some examples, the compute service manager of the primary deployment can log details of the replication request for audit and tracking purposes, which is useful for maintaining records of data access and transfers, especially in environments that require strict compliance with data governance and privacy regulations. This logging helps in troubleshooting, performance monitoring, and ensuring compliance with legal and regulatory standards concerning data management and security.

In operation 504, the compute service manager determines the routing strategy for the data transfer based on the metadata of the replication cache. This decision process assesses whether it is more advantageous to route the data transfer through the replication cache or to send the data transfer directly from the primary deployment to the secondary deployment. For example, the compute service manager can use a cost optimizer, such as cost optimizer 230 of FIG. 2. The cost optimizer determines an optimized routing strategy for routing data traffic during replication group refreshes. The cost optimizer determines whether to route the replication traffic through a replication cache or to bypass the replication cache and replicate directly between a primary deployment and a secondary deployment in a point-to-point data transfer.

In some examples, the cost optimizer uses economic and deployment factors during a dynamic determination in order to make a determination of an optimal data transfer strategy. The cost optimizer can use economic factors and economic and deployment factors such as, but not limited to:
Single Target Deployment: If a listing of a primary deployment is intended for only a single target deployment, such as a private listing meant exclusively for consumers in one secondary deployment, the optimizer can decide against using the replication cache. This is because the benefits of caching, which are primarily derived from serving multiple requests for the same data, do not apply.
Multiple Target Deployments: The cost optimizer can implement a scoring system to evaluate the cost-effectiveness of using the cache. As an example, secondary deployments on different Cloud Service Providers (CSPs) than the primary deployment can be given a first score, indicating higher potential savings from using the replication cache because of typically higher cross-CSP data transfer costs. Secondary deployments within the same CSP as the primary can be scored using a second score having a value that is less than the first score, reflecting the relatively lower cost of intra-CSP data transfers. If the cumulative score from all secondary deployments of a primary deployment meets or exceeds a specified threshold score value, then the cost optimizer can determine that using a replication cache would be economically beneficial, justifying the incurred cache traffic and storage costs.
Complex Replication Groups: In scenarios involving regional reference usage auto-fulfillment replication groups that contain multiple listings, the decision to use the replication cache becomes more complex. These groups might require a nuanced approach since they involve multiple listings potentially shared across different regions. For example, for complex replication groups that contain databases for multiple listings, some listings are meant to be sent globally, some are for a specific region. A compute service manager calculates on a net global basis across all listings that use a specific database, whether to cache that database. In some examples, the compute service manager assesses the usage and demand for the database from various listings globally. Based on factors such as frequency of access, geographical distribution of requests, and potential cost savings, the compute service manager determines the efficacy of caching the database to optimize data retrieval and reduce latency across different regions. This decision-making process integrates data analytics to ensure efficient resource management and improved performance for users accessing the database from various global points.
Per-Database Snapshot Decision: Initially, a simple heuristic based on score computation is used. If any database within the replication group meets or exceeds a specified criteria based on the replication group's score, the entire replication group may utilize the replication cache. In some examples, this approach can be refined to make replication caching decisions at the level of individual database snapshots, depending on observed cache utilization and cost savings.
Snapshot Analysis: A snapshot analysis is utilized as a factor in determining whether to route a data transfer through a replication cache by assessing the current state and changes in the data at the primary deployment relative to the secondary deployments. This analysis involves comparing the latest snapshot of the data files, which represents its most recent state, with previous snapshots or the data files currently held at one or more secondary deployments. By identifying the differences and the volume of data that needs to be updated or synchronized, the cost optimizer can evaluate the cost-effectiveness and efficiency of using a replication cache versus direct data transfers. If the snapshot analysis reveals that multiple secondary deployments can use or might be likely to use similar data updates, routing through a replication cache becomes advantageous as it can significantly reduce redundancy and overall data transfer costs by allowing secondary deployments to fetch only the incremental changes from a centralized replication cache, rather than multiple individual transfers from the primary deployment.

Conversely, if the requested data files are not available in the replication cache or if direct transmission from the primary deployment is less costly due to network conditions or other factors, the cost optimizer can choose to bypass the replication cache. This flexibility in choosing the optimal path for data transfer ensures that the replication process is both fast and resource-efficient, thereby maintaining high system performance and lower costs.

In some examples, a compute service manager of a primary deployment can be the best suited to make a determination to route the data transfer directly to a secondary deployment or to use a replication cache. For example, before the primary deployment produces a snapshot of the datafiles that are requested to be replicated, the primary deployment receives an inventory from the secondary deployment. This inventory provides detailed information about what data the secondary currently holds and what it needs. This information is useful as it allows the primary deployment to make informed decisions about whether to use the replication cache.

Based on the inventory analysis, the primary deployment can decide to use the cache or bypass it for specific refresh tasks. For instance, if the secondary deployment is in a process of initial synchronization and is located within the same Cloud Service Provider (CSP) as the primary deployment, it might be more efficient to bypass the cache to minimize latency and synchronization complexities.

In some examples, a static configuration is used that globally enables or disables cache optimization for each replication group. The static configuration reduces the complexity of the decision-making process by applying a uniform policy across all tasks. While simpler, this approach may not account for the nuances of individual replication tasks. It may lead to suboptimal decisions where dynamic adjustments based on specific data needs and network conditions could have provided better outcomes.

In some examples, data transfer routing determination process is used. Initially, adopting a dynamic decision-making approach offers fine-grained control over cache usage, allowing for optimizations based on real-time data and system state. It supports scenarios where specific conditions, such as the proximity of secondary deployments to the primary or unique synchronization requirements, dictate a tailored approach. Over time, as the system matures and more data on replication patterns and costs becomes available, the cost optimization logic can be enhanced. This can involve integrating machine learning models to predict the most cost-effective strategies based on historical data and trending analysis.

In some examples, continuous monitoring of replication performance and costs is used to identify inefficiencies and provide data that can be used to refine the decision algorithms.

In some examples, a feedback loop is used to garner insights from past replication tasks and inform future decisions. This can enhance the effectiveness of the replication strategy. This adaptive approach ensures that the system remains optimal even as external conditions change.

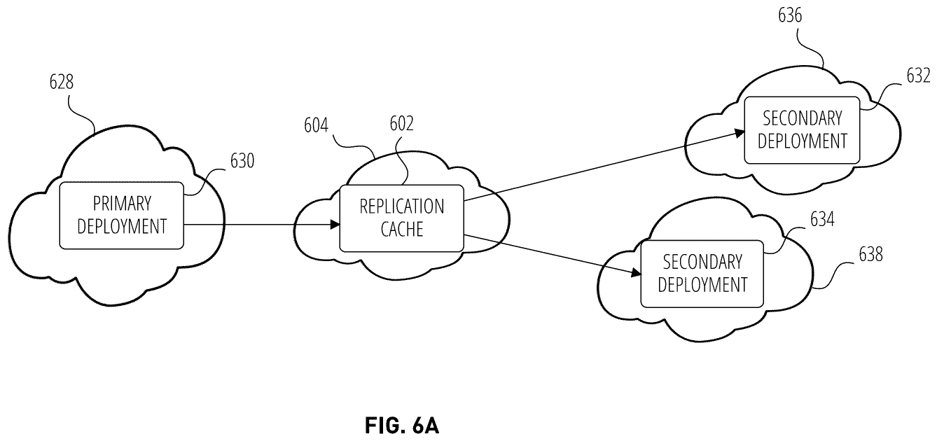

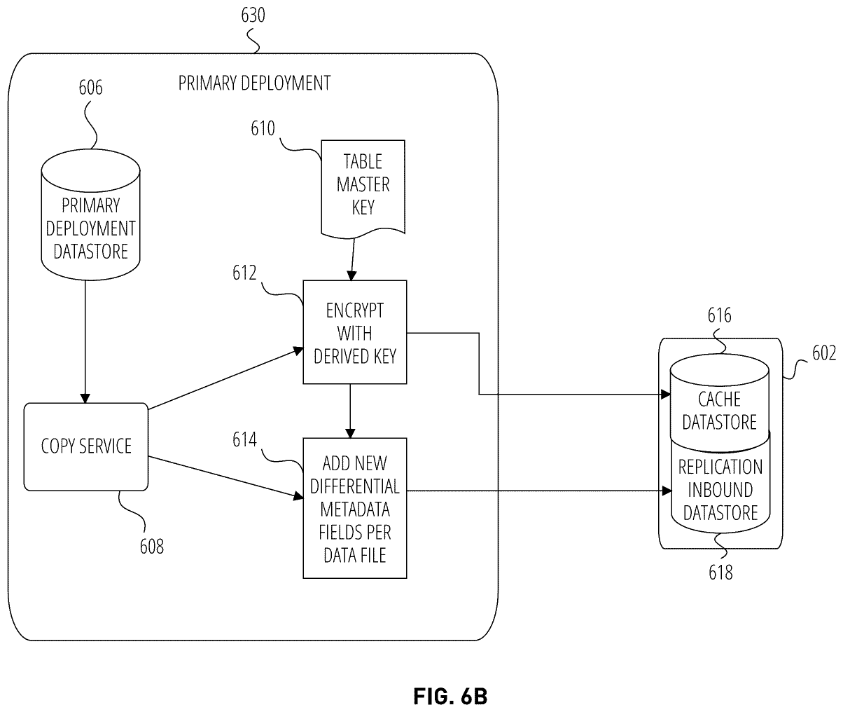

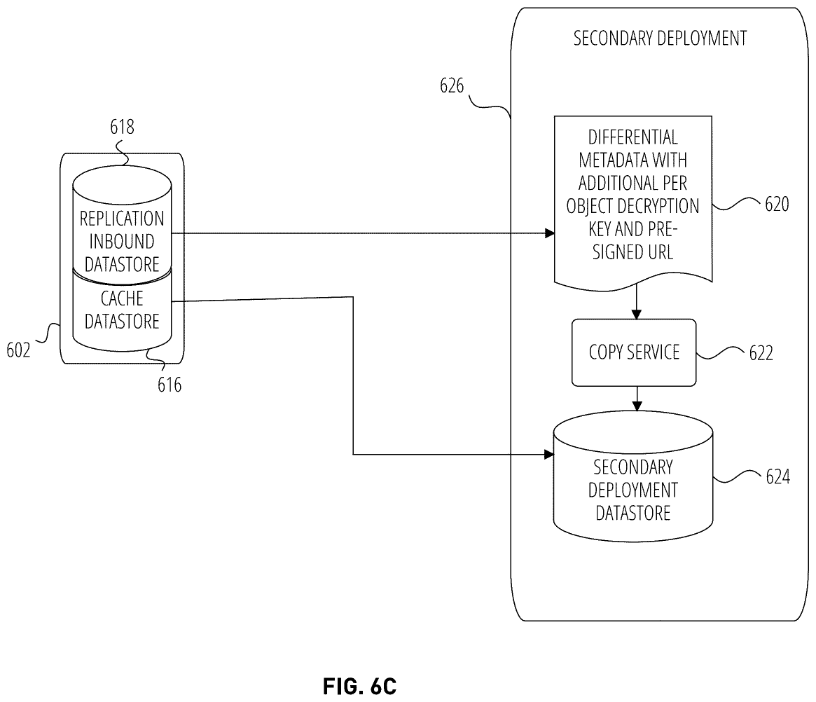

In operation 506, the compute service manager can, in response to determining to route the data transfer through the replication cache, routes the data transfer through the replication cache. For example, routing through the replication cache is executed when it is deemed more efficient or cost-effective compared to direct point-to-point data transfer from the primary deployment to the secondary deployment as more fully described in reference to FIG. 6A, FIG. 6B, and FIG. 6C.

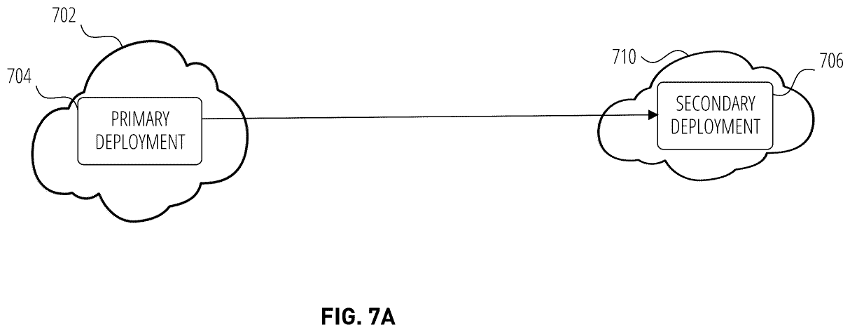

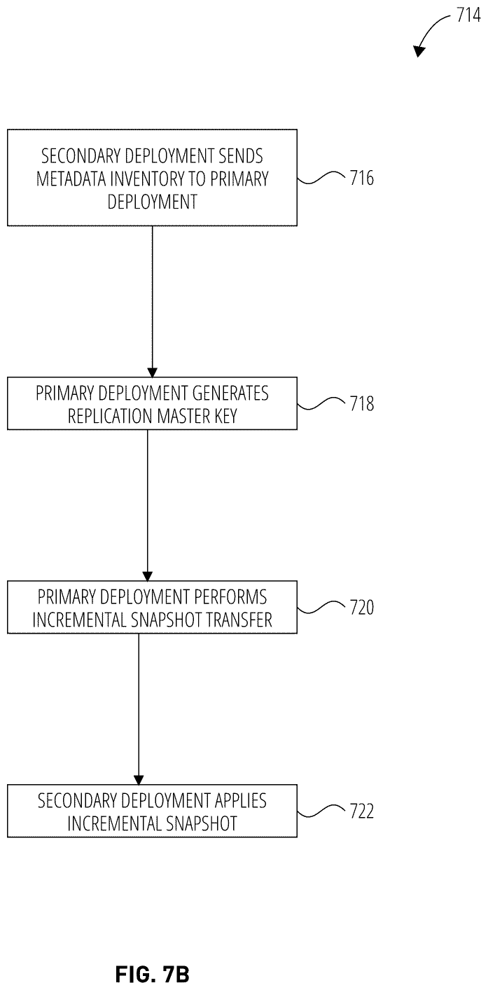

In operation 508, the compute service manager, can, in response to determining to route the data transfer directly from the primary deployment, route the data transfer directly from the primary deployment to the secondary deployment in a point-to-point data transfer as more fully described in reference to FIG. 7A and FIG. 7B.

In some examples, the compute service manager of the secondary deployment verifies receipt of the data transfer. This operation is useful for maintaining the integrity and reliability of the data across distributed systems.

In some examples, the verification process involves a detailed examination of the data files to ensure their completeness and to verify that no files are missing or corrupted. This can include validating the checksums or hashes of the data files, which were calculated prior to the transfer, and comparing them with those of the received data files. To effectively gather information about the received data files, the compute service manager engages with various systems or services at the secondary deployment. This engagement may involve querying databases, checking logs, or interacting with data management services that handle the incoming data files.

In some examples, should any discrepancies or errors be identified during this verification process, such as missing files or data corruption, the compute service manager can take action by logging these incidents. Additionally, the compute service manager can initiate error handling procedures, which can include retransmission requests or alerts to system administrators to rectify the issues. In some examples, detailed logs are maintained throughout this verification process, providing an audit trail that can be utilized for troubleshooting, compliance, and monitoring purposes.

In some examples, upon confirming the successful receipt of the data files without any issues, the compute service manager records this event as successful and updates a system status accordingly. This confirmation enables downstream processes that rely on the availability and integrity of the newly transferred data. It ensures that the secondary deployment can proceed with integrating and utilizing the data in its operations, secure in the knowledge that the data is complete and accurate.

In some examples, the verification process plays a role in reinforcing security and compliance measures. The verification process ensures that the data transfer and receipt adhere to organizational policies and regulatory requirements, including maintaining data integrity and confidentiality throughout the process. This operation not only boosts the reliability of the data replication process but also supports the overall data governance and security framework within the organization, enhancing trust and operational efficiency.

FIG. 6A, FIG. 6B, and FIG. 6C illustrate a replication process using a replication cache, according to some examples. Although the example replication process depicts a particular sequence of operations, the sequence may be altered without departing from the scope of the present disclosure. For example, some of the operations depicted may be performed in parallel or in a different sequence that does not materially affect the function of the routine. In other examples, different components of a computing environment that implements the replication process may perform functions at substantially the same time or in a specific sequence.

In the replication process, a respective compute service manager of a primary deployment 630 and respective one or more compute service managers of one or more secondary deployments (e.g., secondary deployment 632 and secondary deployment 634) coordinate together to use a replication cache 602 to transfer data files from the primary deployment 630 to the one or more secondary deployments. The primary deployment 630, replication cache 602, and the one or more secondary deployments may reside in one or more respective virtual private clouds (e.g., virtual private cloud 1 628, virtual private cloud 2 604, virtual private cloud 3 636, and virtual private cloud N 638. These respective virtual private clouds may be the same virtual private cloud, or any combination of different virtual private clouds. For example, the replication cache 602 may reside in the same virtual private cloud as the one or more secondary deployments while the primary deployment 630 may reside in a different virtual private cloud.

FIG. 6B illustrates a push process by the primary deployment 630 to the replication cache 602. A compute service manager of the primary deployment 630 uses a copy service 608 to decrypt one or more data files stored in a primary deployment datastore 606. In operation 612, the copy service 608 encrypts the data files using a table master key 610. For example, the copy service 608 encrypts the data files to be stored in a cache datastore 616 of the replication cache 602 using a modified key derivation process.

In some examples, the copy service 608 generates a hash of the table master key 610 and one or more attributes of each data file to generate a unique key for each data file being stored in the cache datastore 616. For example, the copy service 608 generates a key using a hash function and the table master key 610, a string literal indicating a purpose of the key, such as “CACHE” or the like, and a file identifier of the data file to be encrypted. This generates a unique encryption key for each data file. This modification ensures that the encryption keys for each cached data file is distinct, thereby enhancing security by segregating the encryption domains.

In some examples, the derived encryption key for each data file is included in a replication snapshot sent to a secondary deployment. This method ensures that the secondary deployment has immediate access to the necessary decryption keys. Including the keys directly can simplify operations at the secondary deployment at the cost of increased complexity in the snapshot management and potentially increased security risks due to the wider distribution of decryption keys.

In some examples, the secondary deployment derives the decryption key if it is provided with the base table master key 610 and a derivation formula. This method reduces the amount of sensitive data transmitted and leverages the existing capabilities of the secondary deployment's copy service.

In some examples, management of the replication cache 602 includes setting appropriate policies for the lifecycle of the cached data files, such as defining time-to-live (TTL) values. In some examples, a key rotation process is used to rekey data files stored in the cache datastore 616. In some examples, instead of re-keying the cached data files, the replication cache 602 is purged for that account as part of Tri-Secret Secure (TSS) enablement. Purging is as cost-effective as re-keying but simplifies the management by removing outdated or unnecessary data.

In operation 614 differential metadata is generated for each cached data file and the endpoints are created in the replication inbound datastore 618 for use by a secondary deployment in pulling the encrypted data files from the cache datastore 616. For example, each data file is stored in the replication cache 602 with a deterministic path that can be derived using the formula: data_file/<account ID>/<child volume shard prefix for perf>/<data_file short name>. This structured approach ensures that the location of each data file in the replication cache 602 is predictable and consistent across different replication jobs, which is useful for efficient retrieval and management of cached files. The use of child volume shards and assigning FDN files to different cache prefixes helps distribute the load evenly across the storage infrastructure, enhancing performance and reducing the risk of bottlenecks.

In some examples, a PutCache operation is used to manage the storage of data files in the replication cache 602. This operation includes several sub-operations:
A GetObject Request: Checks if the data file already exists in the cache.
CopyObject Request: If the file exists, this request updates a last modified timestamp of the cached data file. If the data file is not found (cache miss), this request fails.
PutObject Request: If the file does not exist or the CopyObject request failed, this operation adds the new or updated data file to the replication cache 602.
   These operations ensure that the cache is kept up-to-date with the latest versions of the micropartition files and that redundant data transfers are minimized.

In some examples, the process of generating differential metadata begins with identifying the baseline data snapshot, which serves as the last known good state of the data before any changes occurred. In some examples, as changes are made to the data, the data platform tracks these modifications through mechanisms such as, but not limited to, versioning, timestamps, monitoring write operations to the primary deployment datastore 606, and the like.

In some examples, all detected changes are logged in a structured format, recording the nature of the change (addition, deletion, modification), the data affected, and the specifics of the change (e.g., the new value in case of an update). In some examples, the logged changes are compiled into a differential metadata file, representing the “diff” or the set of differences from the baseline. This file can include identifiers for the changed data and the changes themselves.

In some examples, differential metadata is accessible as a specific endpoint in the replication cache 602 where this differential metadata file is accessible, acting as a handle or a reference point that systems can query to fetch the differential metadata. In some examples, the differential metadata includes information such as, but not limited to, a creation time, a baseline snapshot the differential metadata is based on, access control settings to ensure that only authorized entities can access the differential data, and the like.

In some examples, an endpoint used to access the differential metadata is integrated into a computing environment, allowing applications and services to use this endpoint to fetch differential updates instead of pulling a full data snapshot. This integration often involves updating routing tables or service registries with the differential metadata location and properties. In some examples, when a system component requires an update to the latest data state, it queries the endpoint of the differential metadata, retrieves the differential metadata, and applies the changes included in the differential metadata to the system's local data copy based on the baseline snapshot.

In some examples, replication snapshot metadata of the differential metadata includes the per-data file encryption keys and pre-signed Uniform Resource Locators (URLs) for each data file. These URLs, with a configurable time-to-live (TTL), allow secondary deployments to securely access the cached data files. The inclusion of this metadata in a differential metadata file used for replication ensures that information for used file decryption and access is available to secondary deployments without compromising security.

In some examples, mutable datastore files, which are part of a database replication, are handled separately from immutable data files. The mutable datastore files are cached under a different key based on a content hash, allowing for efficient management and retrieval of frequently updated data.

FIG. 6C illustrates a pull process of a secondary deployment, according to some examples. A compute service manager of a secondary deployment 626 uses a copy service 622 to retrieve differential metadata 620 with additional per object decryption keys and pre-signed URLs from the replication inbound datastore 618 of the replication cache 602. The copy service then uses the differential metadata 620 with additional per object decryption keys and pre-signed URLs to pull encrypted cached data files from the cache datastore 616 of the replication cache 602. The copy service 622 decrypts the cached data files and stores the data files in the secondary deployment datastore 624 of the secondary deployment 626.

In some examples, as the copy service 622 uses pre-signed URLs for accessing data files directly from the cache, the secondary deployment 626 does not need a permanent access volume and shifts towards a more dynamic and cost-effective method of data retrieval.

In some examples, instead of relying on a replication master key to derive decryption keys for each data file, the copy service 622 receives a specific derived encryption key for each file as part of the response to the replication request. This approach enhances security by ensuring that decryption keys are directly managed and distributed without broader exposure, minimizing potential security risks.

In some examples, an amount of data transferred from the cache is monitored and recorded. This monitoring serves multiple purposes such as, but limited to:
Provider and Internal Transparency: Monitoring allows providers and internal systems to see the actual savings and usage, providing clear insights into the benefits of the replication cache system.
Future Flexibility: By maintaining detailed metrics, a data platform can easily adjust to future changes in metering rates or cost structures, ensuring that the data platform remains cost-effective and aligned with financial goals.
Usage Transparency and Data Integrity: Ensuring that metrics regarding data transfer volumes are accurately captured and reported is useful for maintaining transparency with users and for internal tracking. This transparency helps in validating the efficiency of the replication cache system and in making informed decisions about potential adjustments to the system based on usage patterns and cost considerations.

FIG. 7A and FIG. 7B illustrate a point-to-point data transfer, according to some examples. A primary deployment 704 and a secondary deployment 706 coordinate processes to perform a data transfer directly from the primary deployment 704 to the secondary deployment 706. Each deployment has a respective virtual private cloud (e.g., virtual private cloud 702 and virtual private cloud 710). In some examples, the virtual private cloud 702 and the virtual private cloud 710 are the same virtual private cloud.

FIG. 7B illustrates a point to point replication method 714, according to some examples. Respective compute service managers (e.g., compute service manager 104 of FIG. 1) of a primary deployment 704 and a secondary deployment 706 use the point to point replication method 714 to perform a data transfer of one or more data files. Although the point to point replication method 714 depicts a particular sequence of operations, the sequence may be altered without departing from the scope of the present disclosure. For example, some of the operations depicted may be performed in parallel or in a different sequence that does not materially affect the function of the routine. In other examples, different components of a compute service manager that implements the routine may perform functions at substantially the same time or in a specific sequence.

In operation 716, the compute service manager of the secondary deployment 706 sends metadata inventory to the compute service manager of the primary deployment 704. For each data file requested, the secondary deployment 706 sends a metadata inventory to the primary deployment 704. This inventory includes information about the current state of the database on the secondary deployment 706 side. This inventory is used for synchronizing Replication Group (RG) membership and ensuring both sides are aligned on the data files to be replicated.

In operation 718, the compute service manager of the primary deployment 704 generates a replication master key. For example, the primary deployment generates or selects a random replication master key specifically for this refresh cycle. This master key ensures the security of the replication process as the master key is used to derive per data file encryption keys for all data files transmitted during the session.

In operation 720, the compute service manager of the primary deployment performs an incremental snapshot transfer. The compute service manager of the primary deployment analyzes the received metadata to determine incremental changes or objects missing in the database of the secondary deployment 706. This detection is based on the version of tables in the database, and appropriate snapshots (either full or differential) are prepared. Data files of identified objects are queued for transfer. These data files are encrypted inline using keys derived from the replication master key and the file ID, ensuring that data remains secure during transit. The data files are stored at a specific path in the secondary's replication stage, structured as “/snapshots/<copy_request_hash>/<copy_random_prefix>/”, which organizes the data files for retrieval and application.

In operation 722, the compute service manager of the secondary deployment 706 applies an incremental snapshot of the data files to an internal datastore of the secondary deployment 706. For example, the compute service manager of the secondary deployment 706 receives the incremental snapshot and begins integrating the data files of the incremental snapshot into the database of the secondary deployment 706. This involves copying the metadata and data files from the replication stage of the secondary deployment 706 to permanent storage within an account of the secondary deployment 706.

In some examples, the data files, temporarily stored in the replication stage of the secondary deployment 706, undergo a final decrypt-encrypt cycle driven by a copy service of the compute service manager of the secondary deployment. This step is useful for maintaining the security and integrity of the data files as they move into permanent storage.

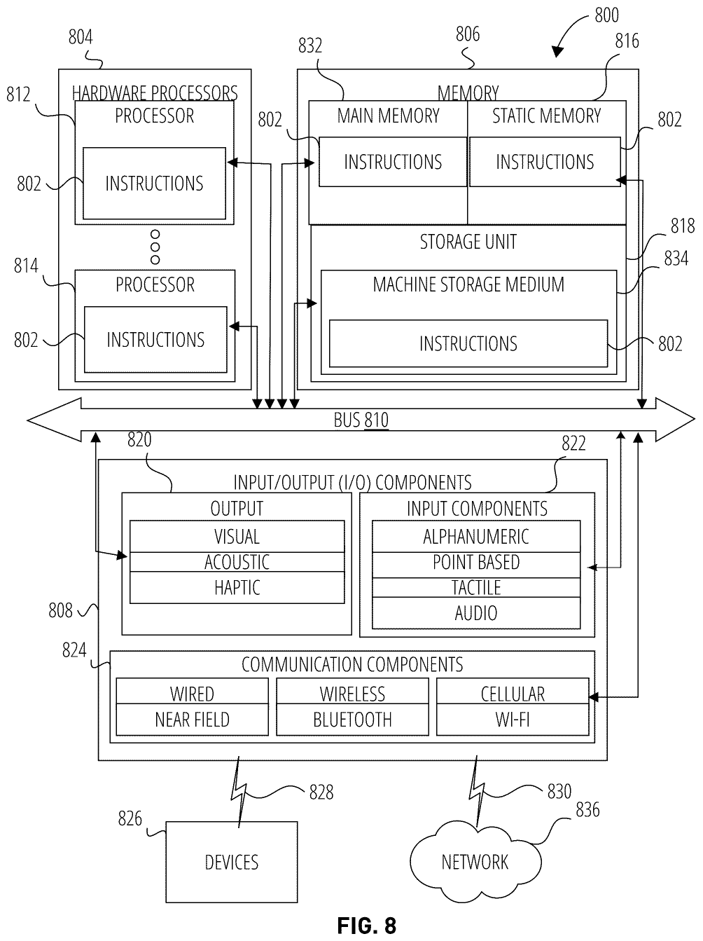

FIG. 8 illustrates a diagrammatic representation of a machine 800 in the form of a computer system within which a set of instructions may be executed for causing the machine 800 to perform any one or more of the methodologies discussed herein, according to examples. Specifically, FIG. 8 shows a diagrammatic representation of the machine 800 in the example form of a computer system, within which instructions 802 (e.g., software, a program, an application, an applet, an application, or other executable code) for causing the machine 800 to perform any one or more of the methodologies discussed herein may be executed. For example, the instructions 802 may cause the machine 800 to execute any one or more operations of any one or more of the methods described herein. In this way, the instructions 802 transform a general, non-programmed machine into a particular machine 800 (e.g., the compute service manager 104, the execution platform 110, and the data storage devices 1 to N of data storage 106) that is specially configured to carry out any one of the described and illustrated functions in the manner described herein.

In alternative examples, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 802, sequentially or otherwise, that specify actions to be taken by the machine 800. Further, while only a single machine 800 is illustrated, the term “machine” shall also be taken to include a collection of machines that individually or jointly execute the instructions 802 to perform any one or more of the methodologies discussed herein.

The machine 800 includes hardware processors 804, memory 806, and I/O components 808 configured to communicate with each other such as via a bus 810. In some examples, the hardware processors 804 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another hardware processor, or any suitable combination thereof) may include, for example, multiple processors as exemplified by processor 812 and a processor 814 that may execute the instructions 802. The term “processor” is intended to include multi-core processors that may comprise two or more independent processors (sometimes referred to as “cores”) that may execute instructions 802 contemporaneously. Although FIG. 8 shows multiple hardware processors 804, the machine 800 may include a single processor with a single core, a single processor with multiple cores (e.g., a multi-core processor), multiple processors with a single core, multiple processors with multiple cores, or any combination thereof.

The memory 806 may include a main memory 832, a static memory 816, and a storage unit 818 including a machine storage medium 834, accessible to the hardware processors 804 such as via the bus 810. The main memory 832, the static memory 816, and the storage unit 818 store the instructions 802 embodying any one or more of the methodologies or functions described herein. The instructions 802 may also reside, completely or partially, within the main memory 832, within the static memory 816, within the storage unit 818, within at least one of the hardware processors 804 (e.g., within the processor's cache memory), or any suitable combination thereof, during execution thereof by the machine 800.

The input/output (I/O) components 808 include components to receive input, provide output, produce output, transmit information, exchange information, capture measurements, and so on. The specific I/O components 808 that are included in a particular machine 800 will depend on the type of machine. For example, portable machines such as mobile phones will likely include a touch input device or other such input mechanisms, while a headless server machine will likely not include such a touch input device. It will be appreciated that the I/O components 808 may include many other components that are not shown in FIG. 8. The I/O components 808 are grouped according to functionality merely for simplifying the following discussion and the grouping is in no way limiting. In various examples, the I/O components 808 may include output components 820 and input components 822. The output components 820 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 822 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 808 may include communication components 824 operable to couple the machine 800 to a network 836 or devices 826 via a coupling 830 and a coupling 828, respectively. For example, the communication components 824 may include a network interface component or another suitable device to interface with the network 836. In further examples, the communication components 824 may include wired communication components, wireless communication components, cellular communication components, and other communication components to provide communication via other modalities. The devices 826 may be another machine or any of a wide variety of peripheral devices (e.g., a peripheral device coupled via a universal serial bus (USB)). For example, as noted above, the machine 800 may correspond to any one of the compute service manager 104, the execution platform 110, and the devices 826 may include the data storage device 226 or any other computing device described herein as being in communication with the data platform 102 or the data storage 106.

The various memories (e.g., 806, 816, 832, and/or memory of the processor(s) 804 and/or the storage unit 818) may store one or more sets of instructions 802 and data structures (e.g., software) embodying or utilized by any one or more of the methodologies or functions described herein. These instructions 802, when executed by the processor(s) 804, cause various operations to implement the disclosed examples.

Described implementations of the subject matter can include one or more features, alone or in combination as illustrated below by way of example:
Example 1 is a method, comprising: receiving a replication request from a secondary deployment of one or more secondary deployments, the replication request including a request for a data transfer of one or more data files from a primary deployment; analyzing metadata of a replication cache and the primary deployment to identify the one or more data files for replication; determining to route the data transfer through the replication cache or directly from the primary deployment to the secondary deployment based on metadata of the replication cache; in response to determining to route the data transfer through the replication cache, routing the data transfer through the replication cache; in response to determining to route the data transfer directly from the primary deployment, routing the data transfer directly from the primary deployment to the secondary deployment; and verifying receipt of the data transfer at the secondary deployment.
In Example 2, the subject matter of Example 1 includes, updating the replication cache with a latest version of the data files in the primary deployment prior to routing the data transfer through the replication cache.
In Example 3, the subject matter of any of Examples 1-2 includes, wherein determining to route the data transfer through the replication cache or directly from the primary deployment to the secondary deployment is further based on a comparison of historical data transfer rates for previous replication activities to current data transfer rates.
In Example 4, the subject matter of any of Examples 1-3 includes, wherein determining to route the data transfer through the replication cache or directly from the primary deployment is further based on a real-time analysis of a cost of the data transfer.
In Example 5, the subject matter of any of Examples 1˜4 includes, encrypting the data files during the data transfer.
In Example 6, the subject matter of any of Examples 1-5 includes, wherein the replication request includes specified data files designated for priority replication based on application requirements.
In Example 7, the subject matter of any of Examples 1-6 includes, wherein the replication cache is located in a geographic region based on access times of the one or more secondary deployments.
In Example 8, the subject matter of any of Examples 1-7 includes, wherein the metadata used in analyzing inventory includes timestamps indicating a last modification time of the data files.
In Example 9, the subject matter of any of Examples 1-8 includes, encrypting the one or more data files using a unique encryption key for each data file of the one or more data files before routing the data transfer through the replication cache.
In Example 10, the subject matter of any of Examples 1-9 includes, decrypting the encrypted data files at the secondary deployment using respective decryption keys unique to each secondary deployment of the one or more secondary deployments.
Example 11 is at least one machine-readable medium including instructions that, when executed by processing circuitry, cause the processing circuitry to perform operations to implement any of Examples 1-10.
Example 12 is an apparatus comprising means to implement any of Examples 1-10.
Example 13 is a system to implement any of Examples 1-10.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 836 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 836 or a portion of the network 836 may include a wireless or cellular network, and the coupling 830 may be a Code Division Multiple Access (CDMA) connection, a Global System for Mobile communications (GSM) connection, or another type of cellular or wireless coupling. In this example, the coupling 830 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 802 may be transmitted or received over the network 836 using a transmission medium via a network interface device (e.g., a network interface component included in the communication components 824) and utilizing any one of a number of well-known transfer protocols (e.g., hypertext transfer protocol (HTTP)). Similarly, the instructions 802 may be transmitted or received using a transmission medium via the coupling 828 (e.g., a peer-to-peer coupling) to the devices 826. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 802 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Described implementations of the subject matter can include one or more features, alone or in combination as illustrated below by way of example.
Example 1 is a method comprising: receiving a replication request from a secondary deployment of one or more secondary deployments, the replication request including a request for a data transfer of one or more data files from a primary deployment; analyzing metadata of a replication cache and the primary deployment to identify the one or more data files for replication; making a determination whether to route the data transfer through the replication cache or directly from the primary deployment to the secondary deployment based on metadata of the replication cache; based on the determination, performing one of: routing the data transfer through the replication cache; or routing the data transfer directly from the primary deployment to the secondary deployment; and verifying receipt of the data transfer at the secondary deployment.
In Example 2, the subject matter of Example 1 includes, updating the replication cache with a latest version of the data files in the primary deployment prior to routing the data transfer through the replication cache.
In Example 3, the subject matter of any of Examples 1-2 includes, wherein determining to route the data transfer through the replication cache or directly from the primary deployment to the secondary deployment is further based on a comparison of historical data transfer rates for previous replication activities to current data transfer rates.
In Example 4, the subject matter of any of Examples 1-3 includes, wherein determining to route the data transfer through the replication cache or directly from the primary deployment is further based on a real-time analysis of a cost of the data transfer.
In Example 5, the subject matter of any of Examples 1˜4 includes, encrypting the data files during the data transfer.
In Example 6, the subject matter of any of Examples 1-5 includes, wherein the replication request includes specified data files designated for priority replication based on application requirements.
In Example 7, the subject matter of any of Examples 1-6 includes, wherein the replication cache is located in a geographic region based on access times of the one or more secondary deployments.
In Example 8, the subject matter of any of Examples 1-7 includes, wherein the metadata used in analyzing inventory includes timestamps indicating a last modification time of the data files.
In Example 9, the subject matter of any of Examples 1-8 includes, encrypting the one or more data files using a unique encryption key for each data file of the one or more data files before routing the data transfer through the replication cache.
In Example 10, the subject matter of any of any of Examples 1-9 includes, decrypting the data files at the secondary deployment using respective decryption keys unique to each secondary deployment of the one or more secondary deployments.
Example 11 is at least one machine-readable medium including instructions that, when executed by processing circuitry, cause the processing circuitry to perform operations to implement any of Examples 1-10.
Example 12 is an apparatus comprising means to implement any of Examples 1-10.
Example 13 is a system to implement any of Examples 1-10.
Example 14 is a method to implement any of Examples 1-10.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

What is claimed is:

1. A method comprising:
receiving a replication request from a secondary deployment of one or more secondary deployments, the replication request including a request for a data transfer of one or more data files from a primary deployment;
analyzing metadata of a replication cache and the primary deployment to identify the one or more data files for replication;
making a determination whether to route the data transfer through the replication cache or directly from the primary deployment to the secondary deployment based on metadata of the replication cache;
based on the determination, performing one of:
routing the data transfer through the replication cache; or
routing the data transfer directly from the primary deployment to the secondary deployment; and
verifying receipt of the data transfer at the secondary deployment.

2. The method of claim 1, further comprising:
updating the replication cache with a latest version of the data files in the primary deployment prior to routing the data transfer through the replication cache.

3. The method of claim 1, wherein determining to route the data transfer through the replication cache or directly from the primary deployment to the secondary deployment is further based on a comparison of historical data transfer rates for previous replication activities to current data transfer rates.

4. The method of claim 1, wherein determining to route the data transfer through the replication cache or directly from the primary deployment is further based on a real-time analysis of a cost of the data transfer.

5. The method of claim 1, further comprising encrypting the data files during the data transfer.

6. The method of claim 1, wherein the replication request includes specified data files designated for priority replication based on application requirements.

7. The method of claim 1, wherein the replication cache is located in a geographic region based on access times of the one or more secondary deployments.

8. The method of claim 1, wherein the metadata used in analyzing inventory includes timestamps indicating a last modification time of the data files.

9. The method of claim 1, further comprising:
encrypting the one or more data files using a unique encryption key for each data file of the one or more data files before routing the data transfer through the replication cache.

10. The method of claim 1, further comprising decrypting the data files at the secondary deployment using respective decryption keys unique to each secondary deployment of the one or more secondary deployments.

11. A system comprising:
at least one processor; and
at least one memory storing instructions that, when executed by the at least one processor, cause the system to perform operations comprising:
receiving a replication request from a secondary deployment of one or more secondary deployments, the replication request including a request for a data transfer of one or more data files from a primary deployment;
analyzing metadata of a replication cache and the primary deployment to identify the one or more data files for replication;
making a determination whether to route the data transfer through the replication cache or directly from the primary deployment to the secondary deployment based on metadata of the replication cache;
based on the determination, performing one of:
routing the data transfer through the replication cache; or
routing the data transfer directly from the primary deployment to the secondary deployment; and
verifying receipt of the data transfer at the secondary deployment.

12. The system of claim 11, wherein the operations further comprise:
updating the replication cache with a latest version of the data files in the primary deployment prior to routing the data transfer through the replication cache.

13. The system of claim 11, wherein determining to route the data transfer through the replication cache or directly from the primary deployment to the secondary deployment is further based on a comparison of historical data transfer rates for previous replication activities to current data transfer rates.

14. The system of claim 11, wherein determining to route the data transfer through the replication cache or directly from the primary deployment is further based on a real-time analysis of a cost of the data transfer.

15. The system of claim 11, wherein the operations further comprise encrypting the data files during the data transfer.

16. The system of claim 11, wherein the replication request includes specified data files designated for priority replication based on application requirements.

17. The system of claim 11, wherein the replication cache is located in a geographic region based on access times of the one or more secondary deployments.

18. The system of claim 11, wherein the metadata used in analyzing inventory includes timestamps indicating a last modification time of the data files.

19. The system of claim 11, wherein the operations further comprise:
encrypting the one or more data files using a unique encryption key for each data file of the one or more data files before routing the data transfer through the replication cache.

20. The system of claim 11, wherein the operations further comprise decrypting the data files at the secondary deployment using respective decryption keys unique to each secondary deployment of the one or more secondary deployments.

21. A machine-storage medium storing instructions that, when executed by one or more processors of a system, cause the system to perform operations comprising:
receiving a replication request from a secondary deployment of one or more secondary deployments, the replication request including a request for a data transfer of one or more data files from a primary deployment;
analyzing metadata of a replication cache and the primary deployment to identify the one or more data files for replication;
making a determination whether to route the data transfer through the replication cache or directly from the primary deployment to the secondary deployment based on metadata of the replication cache;
based on the determination, performing one of:
routing the data transfer through the replication cache; or
routing the data transfer directly from the primary deployment to the secondary deployment; and
verifying receipt of the data transfer at the secondary deployment.

22. The machine-storage medium of claim 21, wherein the operations further comprise:
updating the replication cache with a latest version of the data files in the primary deployment prior to routing the data transfer through the replication cache.

23. The machine-storage medium of claim 21, wherein determining to route the data transfer through the replication cache or directly from the primary deployment to the secondary deployment is further based on a comparison of historical data transfer rates for previous replication activities to current data transfer rates.

24. The machine-storage medium of claim 21, wherein determining to route the data transfer through the replication cache or directly from the primary deployment is further based on a real-time analysis of a cost of the data transfer.

25. The machine-storage medium of claim 21, wherein the operations further comprise encrypting the data files during the data transfer.

26. The machine-storage medium of claim 21, wherein the replication request includes specified data files designated for priority replication based on application requirements.

27. The machine-storage medium of claim 21, wherein the replication cache is located in a geographic region based on access times of the one or more secondary deployments.

28. The machine-storage medium of claim 21, wherein the metadata used in analyzing inventory includes timestamps indicating a last modification time of the data files.

29. The machine-storage medium of claim 21, wherein the operations further comprise:
encrypting the one or more data files using a unique encryption key for each data file of the one or more data files before routing the data transfer through the replication cache.

30. The machine-storage medium of claim 21, wherein the operations further comprise decrypting the data files at the secondary deployment using respective decryption keys unique to each secondary deployment of the one or more secondary deployments.
